(19) United States
(12) Patent Application Publication
(10) Pub. No.: US 2020/0180988 A1
(43) Pub. Date: Jun. 11, 2020

(54) WATER SYSTEM HAVING UV FUNCTION AND METHOD FOR CONTROLLING SAME

(71) Applicants: Xiaoping CHEN, Guangdong (CN); FOSHAN VIOMI ELECTRICAL TECHNOLOGY CO., LTD., Guangdong (CN)

(72) Inventor: Xiaoping CHEN, Guang dong (CN)

(21) Appl. No.: 16/617,533

(22) PCT Filed: May 24, 2018
(86) PCT No.: PCT/CN2018/088211

§ 371 Date: Nov. 27, 2019

(30) Foreign Application Priority Data
Jun. 10, 2017 (CN) 201710434808.4

(51) Int. Cl. C02F 9/00

(52) U.S. Cl. CPC C02F 9/00; C02F 2209/40; C02F 2303/04; C02F 1/001; C02F 2201/326; C02F 2209/006; C02F 2201/005

(57) ABSTRACT

Disclosed is a water system having a UV function, comprising a water route (, a water flow sensor (2), a filter core assembly (3), a UV sterilising device (4), a solenoid valve (5) and an electric control device (6), wherein the electric control device (6) is respectively electrically connected to the water flow sensor (2), the UV sterilising device (4) and the solenoid valve (5), the electric control device (6) receives a water flow signal transmitted from the water flow sensor (2), and, according to the water flow signal, controls the operation of the UV sterilising device (4) and the solenoid valve (5) When sensing a signal that water flow is passing through the water route, the water system having a UV function automatically starts the UV sterilising device (4) and the solenoid valve (5), conversely, when the signal indicate that no water flow is passing through the water route, the UV sterilising device (4) and the solenoid valve (5) are shut down, preventing the UV sterilising device (4) from conducting electricity and operating long term, both consuming electricity and affecting the service life, and by means of shutting off the water route, the solenoid valve (5) can prevent secondary contamination to the water route, so the whole water system has a simple and rational structure. Further disclosed is a method for controlling the water system having a UV function.

### BACKGROUND OF THE INVENTION

The present invention relates to a water system, and in particular to a water system with a UV function and a method of control ling the same.

For a water system in the prior art, especially a water filtration (purification) system, such as a water purifier, water is directly discharged from a water outlet end for a user to drink after one or more layers of filtration. However, the above traditional water system still has the following deficiencies: (1) water is only filtered and cannot effectively inhibit or remove impurities in the water such as bacteria; (2) when there is no water flow (not working) in the water system, if a UV sterilization device is in an energized working state for a long time, the water system consumes electricity and affects the service life of the UV sterilization device; (3) furthermore, when there is no water flowing in a waterway, the waterway cannot be cut off in time (for example, a water outlet is closed), and a waterway end (such as the waterway after the filter element assembly) is susceptible to secondary pollution.

### BRIEF SUMMARY OF THE INVENTION

The object of the present invention is to overcome the deficiencies of the prior art described above, and to provide a simple and reasonable structure, which effectively inhibits or removes impurities in water such as bacteria. Further, a UV sterilization device can work only when water flows therethrough, which saves electricity, extends service life, and prevents secondary pollution.

Another object of the present invention is to provide a method for automatically controlling the operation of a UV sterilization device and a solenoid valve of a water system.

The object of the invention is achieved in this way:

A water system with a UV function comprises a waterway, the waterway comprises a water inlet end and a water outlet end, and further comprises the following accessories:

a water flow sensor, arranged on the waterway, and used for real-time collecting water flow signals whether water passes through the waterway, and transmitting out the collected water flow signals;

a filter element assembly, arranged on the waterway to filter the water flowing therethrough;

a UV sterilization device, arranged on the waterway between the filter element assembly and the water outlet end for performing UV sterilization for water flowing therethrough; and

a solenoid valve, arranged on the waterway to control the flow quantity of water;

The electric control device is electrically connected with the water flow sensor, the UV sterilization device and the solenoid valve, respectively, and receives water flow signals transmitted by the water flow sensor, and controls the operation of the UV sterilization device and the solenoid valve according to the water flow signals. By adding the water flow sensor, the UV sterilization device and the solenoid valve, the water system with the UV function effectively inhibits or removes impurities in water such as bacteria by means of the control of the electric control device. Further, when signals indicating the passage of water in a waterway is sensed, the UV sterilization device and the solenoid valve are automatically turned on. Conversely, when there are no the water flow signals in the waterway, the UV sterilization device and the solenoid valve are turned off, thereby preventing the long-term energization of the UV sterilization device, which consumes electricity and affects the service life. Further, the solenoid valve can prevent the secondary pollution of the waterway by closing the waterway. The whole water system has a simple and reasonable structure.

As a more specific solution:

Further, the UV sterilization device is a cold cathode UV ultraviolet germicidal lamp and has good working stability and long service life.

Further, the solenoid valve is arranged on the waterway between the UV sterilization device and the water outlet end so that the water that is about to flow out is both performed with UV sterilization.

Further, the solenoid valve is a normally closed solenoid valve, that is, when the waterway is stationary, the solenoid valve is normally closed. Only when the water flow sensor senses the flow of water, the electronic control device controls the normally closed the solenoid valve to be energized to open, so that the waterway (a water outlet end) is opened.

Further, the water flow sensor is arranged on the waterway between the water inlet end and the filter element assembly, that is, the water flow sensor can sense in real time the water flow signals that are about to enter the, filter element assembly.

Further, a check valve is further arranged between the water flow sensor and the filter element assembly to ensure water flow sequence and prevent the filter element assembly from flowing backward (backflow) under reverse pressure.

The check valve may adopt another solution, and a check valve is further arranged on the waterway between the water inlet end and the filter element assembly, ensuring the flow sequence and preventing the filter element assembly from flowing backward (the backflow) under the reverse pressure.

Further, the bottom of the filter element assembly is provided with a water inlet and a water outlet. The filter element assembly is connected in series on the waterway via the water inlet and the water outlet to ensure that water in the waterway shall be filtered via the filter element assembly. Further the design of the water inlet and the water outlet at the bottom is more convenient for the filter element assembly to be installed on the waterway, that is, the connection is easier.

Further, the filter element assembly comprises a preposition filter element set and an ultrafiltration filter element. The preposition filter element set comprises two or more inner and outer filter element layers consisting of two or more filter element materials. The water enters the preposition filter set via the water inlet, passes through the ultrafiltration filter element and outflows via the water outlet. That is, the filter element assembly is a composite filter element, which is more conducive to increasing a filtering effect.

Another object of the invention is achieved in this way:

A method of controlling a water system with a UV function is provided. A water flow sensor collects signals of water flow flowing through a waterway in re al time, and transmits the water flow signal to an electric control device. The electronic control device determines the water flow signals according to a preset software program to control the operation of a UV sterilization device and the solenoid valve, to enable the water system to achieve smart automatic control, effectively inhibit or remove impurities in the water such as bacteria, and prevent the UV sterilization device from energizing for a long time. The solenoid valve automatically closes the waterway to prevent secondary pollution.

The beneficial effects of the present invention are as follows:

(1) This water system with the UV function can effectively inhibit or remove impurities in the water such as bacteria by adding the water flow sensor, the UV sterilization device and the solenoid valve by means of the control of the electric control device. Further, when signals indicating the passage of water in a waterway is sensed, the UV sterilization device and the solenoid valve are automatically turned on. Conversely, when there are no the water flow signals in the waterway, the UV sterilization device and the solenoid valve are turned off, thereby preventing the long-term energization of the UV sterilization device, which consumes electricity and affects the service life. Further, the solenoid valve can prevent the secondary pollution of the waterway by closing the waterway. The whole water system has a simple and reasonable structure.

(2) Further, by adding the check valve in the waterway, the flow sequence is ensured, and the filter element assembly is prevented from flowing backward (the backflow) under reverse pressure.

(3) In addition, the bottom of the filter element assembly is provided with the water inlet and the water outlet, which is more convenient for the filter element assembly to be installed on the waterway, that is, the connection is easier. Further, the element assembly is a composite filter element, which is more favorable for improving the filtration effect.

### BRIEF DESCRIPTION OF THE DRAWINGS

FIG. 1 is a schematic diagram of a water system with UV function according to the present invention.

### DETAILED DESCRIPTION OF THE INVENTION

The present invention is further described below in conjunction with the accompanying drawings and embodiments:

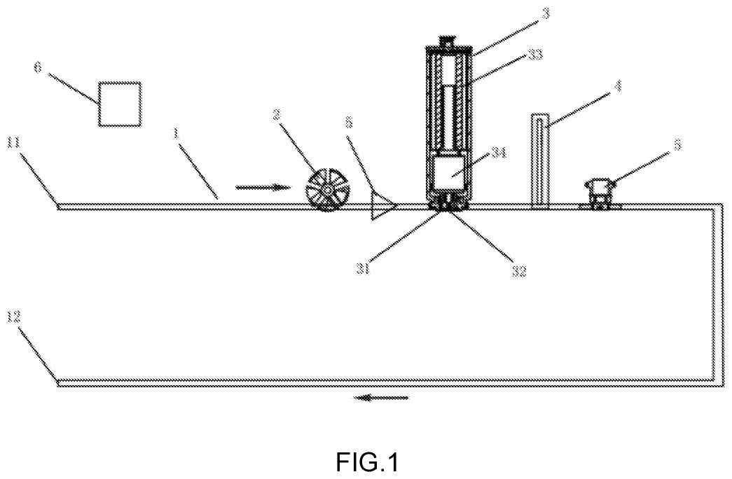

Referring to FIG. 1, a water system with UV function comprises a waterway 1, wherein the waterway comprises a water inlet end 11 and a water outlet end 12, and further comprises the following accessories:

a water flow sensor 2, arranged on the waterway 1, and used for re e collecting water flow signals whether water passes through the waterway, and transmitting out the collected water flow signals;

a filter element assembly 3, arranged on the waterway 1, to filter the water flowing therethrough;

a UV sterilization device 4, arranged on the waterway 1 between the filter element assembly 3 and the water outlet end 12 for performing UV sterilization for water flowing therethrough; and

a solenoid valve 5, arranged on the control the flow quantity of water;

an electric control device 6, electrically connected;to the water flow sensor 2, the UV sterilization device 4 and the solenoid valve 5, respectively, and receiving the water flow signals transmitted from the water flow sensor 2, and controlling the operation of the UV sterilization device 4 and the solenoid valve according to the water flow, signals,

In the embodiment of the present invention, the UV sterilization device 4 may be a cold cathode UV ultraviolet germicidal lamp, and the solenoid valve 5 is a normally dosed solenoid valve arranged on the waterway 1 between the UV sterilization device 4 and the water outlet end 12.

The water flow sensor 2 is arranged on the waterway 1 between the water inlet end 11 and the filter element assembly 3, and a check valve 7 is further arranged between the water flow sensor 2 and the filter element assembly 3. Of course, the check valve 7 can also be arranged on the waterway 1 between the water inlet end 11 and the filter element assembly 3 to prevent backflow.

In order to facilitate the assembly and disassembly of the filter element assembly 3, the bottom of the filter element assembly 3 is provided with a water inlet 31 and a water outlet 32, and the filter element assembly 3 is connected in series to the waterway 1 via the water inlet 31 and the water outlet 32.

The filter element assembly 3 comprises a preposition filter element set 33 and an ultrafiltration filter element 34 The preposition filter element set 33 comprises two or more inner and outer filter element layers consisting of two or more filter element materials. Water enters the preposition filter set 33 via the water inlet 31, passes through the ultrafiltration filter element 34, and flows out from the water outlet 32.

A method for controlling a water system with a UV function is provided, wherein a water flow sensor 2 collects signals of water flow flowing through the waterway 1 in real time, and transmits the water flow signals to an electronic control device 6, and the electronic control device 6 is based on preset software program to determine the water flow signals to control the operation of a UV sterilization device 4 and a solenoid valve 5.

Working principle: When the water flow sensor 2 senses a signal that the water flow passes through the waterway 1, the UV sterilization device 4 and the solenoid valve 5 are automatically turned on. Conversely, when there are no signals of water flow flowing in the waterway 1, the UV sterilization device 4 and the solenoid valve 5 are closed to prevent the UV sterilization device 4 from being energized for a long time, which consumes electricity and affects the service life. The solenoid valve 5 can prevent the waterway (the end section of the waterway of the filter assembly 3 and the water outlet 12) from secondary pollution by closing the waterway 1. The entire water system structure is simple and reasonable.

1. A water system with a UV function, comprising a waterway (1), wherein the waterway (1) comprises a water inlet end (11) and a water outlet end (12), the water system further comprises the following accessories:
a water flow sensor (2), arranged on the waterway (1), and used for real-time collecting water flow signals whether water passes through the waterway, and transmitting out the collected water flow signals;
a filter element assembly (3), arranged on the waterway (1) to filter the water flowing therethrough;
a UV sterilization device (4), arranged on the waterway (1) between the filter element assembly (3) and the water outlet end (12) for performing UV sterilization for water flowing therethrough;
a solenoid valve (5), arranged on the waterway (1) for controlling the flow quantity of water; an electric control device (6), electrically connected to the water flow sensor (2), the UV sterilization device (4) and the solenoid valve (5), respectively, receiving the water flow signals transmitted by the water flow sensor (2), and controlling the operation of the UV sterilization device (4) and the solenoid valve (5) according to the water flow signals.

2. The water system with the UV function according to claim 1, wherein the UV sterilization device (4) is a cold cathode UV ultraviolet germicidal lamp.

3. The water system with the UV function according to claim 1, wherein the solenoid valve (5) is arranged on the waterway (1) between the UV sterilization device (4) and the water outlet end (12).

4. The water system with the UV function according to wherein the solenoid valve (5) is a normally closed solenoid valve.

5. The water system with the UV function according to claim 1, wherein the water flow sensor (2) is arranged on the waterway (1) between the water inlet end (11) and the filter element assembly (3).

6. The water system with the UV function according to claim 5, wherein a check valve 7 is arranged between the water flow sensor 2 and the filter element assembly 3.

7. The water system with the UV function according to claim 1, wherein the waterway (1) between the water inlet end (11) and the filter element assembly (3) is further provided thereon with the check valve (7).

8. The water system with the UV function according to claim 1, wherein the bottom of the filter element assembly (3) is provided with a water inlet (31) and a water outlet (32), and the filter element assembly (3) is connected in series on the waterway (1) via the water inlet (31) and the water outlet (32).

9. The water system with the UV function according to claim 1, wherein the filter element assembly (3) comprises a preposition filter element set (33) and an ultrafiltration filter element (34), the preposition filter element set (33) comprises two or more inner and outer filter element layers consisting of two or more filter element materials, the water enters the preposition filter set (33) via the water inlet (31), passes through the ultrafiltration filter element (34) and outflows via the water outlet (32).

10. A method for controlling a water system with a UV function according to claim 1, wherein a water flow sensor (2) collects signals of water flow flowing through a waterway (1) in real time and transmits the water flow signals to an electronic control device (6), the electronic control device (6) determines the water flow signals according to a preset software program to control the operation of a UV sterilization device (4) and a solenoid valve (5).
